(19) United States
(12) Patent Application Publication
(10) Pub. No.: US 2025/0244742 A1
(43) Pub. Date: Jul. 31, 2025

(54) WORKPIECE VISUALIZATION SYSTEMS AND METHODS

(71) Applicant: Milwaukee Electric Tool Corporation, Brookfield, WI (US)

(72) Inventors: Bruce Garland, Brookfield, WI (US); John J. Rymsza, Brookfield, WI (US); Samuel Petre, Brookfield, WI (US); Julia Savich, Brookfield, WI (US); Adam Schroeder, Brookfield, WI (US); Kevin Brotz, Brookfield, WI (US); Samuel Gould, Brookfield, WI (US); Dayton Aardema, Brookfield, WI (US)

(21) Appl. No.: 19/040,109

(22) Filed: Jan. 29, 2025

Related U.S. Application Data
(60) Provisional application No. 63/626,487, filed on Jan. 29, 2024.
(60) Provisional application No. 63/641,206, filed on May 1, 2024.
(60) Provisional application No. 63/671,368, filed on Jul. 15, 2024.

(51) Int. Cl. G05B 19/4097

(52) U.S. Cl. CPC G05B 19/4097; G05B 2219/35134

(57) ABSTRACT

A method of manufacturing a workpiece can include building a three-dimensional model of a workpiece within a visualization system stored on computing device, inputting measurement data into the visualization system corresponding to predetermined segments of the workpiece, updating the three-dimensional model based on the inputted measurement data to generate a updated three-dimensional model, and based on the inputted measurement data, manufacturing the workpiece to match the updated three-dimensional model.

### CROSS-REFERENCE TO RELATED APPLICATIONS

This application claims the benefit of U.S. Provisional Application No. 63/626,487, filed Jan. 29, 2024, U.S. Provisional Application No. 63/641,206, filed May 1, 2024, and U.S. Provisional Application No. 63/671,368, filed Jul. 15, 2024, each of which are hereby incorporated by reference in their entirety.

### BACKGROUND

In construction applications, the fabrication of a workpiece (e.g., a piece of electrical metallic tubing (EMT) or conduit) may be a labor-intensive process that requires a user to manually take linear measurements, calculate bend angles, and determine the orientation of the workpiece (e.g., conduit, etc.) in space.

### SUMMARY

Some aspects of the disclosure provide a method of manufacturing a workpiece. The method can include building a three-dimensional model of a workpiece within a visualization system stored on computing device, inputting measurement data into the visualization system corresponding to predetermined segments of the workpiece, updating the three-dimensional model based on the inputted measurement data to generate a updated three-dimensional model, and based on the inputted measurement data, manufacturing the workpiece to match the updated three-dimensional model.

Some aspects of the disclosure provide a visualization system for manufacturing a workpiece. The visualization system can include a user visualization interface to generate a three-dimensional model of a workpiece in response to an input from a user, a measurement input interface to receive measurement data corresponding to predetermined segments of the workpiece, and an instruction interface to update the three-dimensional model based on the received measurement data to generate an updated three-dimensional model. The instruction interface can further generate instructions for manufacturing the workpiece.

Some aspects of the disclosure provide a method of manufacturing a workpiece. The method can include designing a model of a workpiece within a visualization system stored on computing device by selecting predetermined segments of the workpiece within the visualization system to build the model of the workpiece, the predetermined segments having a nominal length, pairing a first connected tool to the visualization system, the first tool wirelessly transmitting measurement data corresponding to the predetermined segments of the workpiece to a measurement input interface of the visualization system, updating the segments of the model based on the inputted measurement data to generate an updated model with the segments having a length determined by the measurement input interface, pairing a second connected tool to the visualization system, the second tool wirelessly receiving manufacturing instructions from the visualization system to manufacture the model, and manufacturing the workpiece via the second connected tool to match the updated model

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a diagrammatic view of connected tool system according to aspects of the present disclosure.

FIG. 2 is a diagrammatic view of a visualization system of the connected tool system of FIG. 1.

FIG. 3 is a flowchart depicting of an example use case of the visualization system of FIG. 2.

FIG. 4 shows an example of a user visualization interface of the visualization system of FIG. 2.

FIG. 5 shows another example of the user visualization interface of FIG. 4.

FIG. 6 shows another example of the user visualization interface of FIG. 4.

FIG. 7 shows another example of the user visualization interface of FIG. 4.

FIG. 8 shows another example of the user visualization interface of FIG. 4.

FIG. 9A shows another example of the user visualization interface of FIG. 4.

FIG. 9B shows another example of the user visualization interface of FIG. 4.

FIG. 10 shows another example of the user visualization interface of FIG. 4.

FIG. 11 shows an example of a measurement input interface of the visualization system of FIG. 2.

FIG. 12 shows another example of the measurement input interface of FIG. 11.

FIG. 13 shows another example of the measurement input interface of FIG. 11.

FIG. 14 shows an example of a review interface of the visualization system of FIG. 2.

FIG. 15 shows another example of the review interface of FIG. 14.

FIG. 16 shows another example of the review interface of FIG. 14.

FIG. 17 shows another example of the review interface of FIG. 14.

FIG. 18 shows another example of the review interface of FIG. 14.

FIG. 19 shows an example of an instruction interface of the visualization system of FIG. 2.

FIG. 20 shows another example of the instruction interface of FIG. 19.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

As generally noted above, the fabrication of a workpiece may be a labor-intensive process that requires a user to manually take linear measurements, calculate bend angles, and determine the orientation of the workpiece in space. For example, currently, measurements and calculations are all handled through on-the-job training and reference books or applications. Further, users must plan the workpiece orientation mentally, without a visual representation of how the final product will look. As a result, the fabrication of the workpiece can be a time-consuming and error prone process, which is undesirable in many construction applications.

To mitigate these issues, the user may utilize a visualization system (e.g., a mobile application), which may generate a model (e.g., a three-dimensional model) of the workpiece. In one example, the user may manually create a generalized workpiece that extends from a first location to a second location. The user may then use a tool (e.g., a tape measure, digital tape measure, or other measuring device) to take measurements as instructed by the visualization system. For example, these measurements may correspond to a work area where the workpiece is desired to be placed (e.g., between the first and second points). Further, in conduit pipe applications, the user may indicate where a pipe bend needs to be located, outlet locations, length, height, etc. The measurement data is then wirelessly communicated to a computing device (e.g., a mobile device, server, etc.) and associated with segments of the generalized workpiece in the visualization. In other examples, the measurement data may be manually inputted into the device via the user and associated with segments of the workpiece. The visualization system may then generate a three-dimensional rendering of the workpiece within the simulated environment based on the inputted measurements, which automatically calculates the bend angles and positions on the workpiece.

In some examples, the system may generate instructions and send instructions to one or more connected tools (e.g., wirelessly connected tools), which may automatically bend, cut, or otherwise shape the workpiece according to the inputted measurements. For example, an automated bender may make bends at the appropriate locations so that the workpiece fits within the desired area. In some examples, the system may generate step-by-step written instructions, which a user may follow to create the desired workpiece.

In use, the visualization system may wirelessly communicate with one or more tools to provide the measurement information to the tool (e.g., for bend locations, cut locations, etc.). In another example, the system may render a three-dimensional model of the work area including the workpiece as generated according to the measurements provided by the user. For example, the application may calculate the lengths, bend locations, and orientations based on the measurements provided by the user.

In some examples, the three-dimensional model generated by the visualization system permits a user to identify potential issues with workpiece fitment prior to cutting, bending, or otherwise working on the workpiece, which may reduce overall time and material usage. The model generated by the visualization system may be a real-time model that provides input to a user on how and where to take measurements or position the pipe.

In one example, the visualization system may automatically calculate the necessary bend radii, shrinkage, and linear measurements needed to recreate the model based on the measurements inputted by the user (e.g., wirelessly or manually inputted). In some examples, the visualization system may wirelessly communicate these values to an external tool. Alternatively or additionally, the visualization system may depict these calculated bend radii or other measurements to a user, which shows a user where to cut, bend, or place the pipe.

As mentioned above, the visualization system permits a user to create a three-dimensional model by selecting modeled components that represent major elements of the real world digitally (e.g., pipe components, bends, etc.). Thus, the user may build a three-dimensional model of the desired workpiece within the visualization system. Following this, the user may associate measurements to that application-generated model to create data that can instruct a user on where to cut or bend a workpiece or provide instructions to a tool to automatically cut or bend a workpiece. In some examples, the measurement data can be provided wirelessly (e.g., via a digital tape measure) or via manual user input through a user interface.

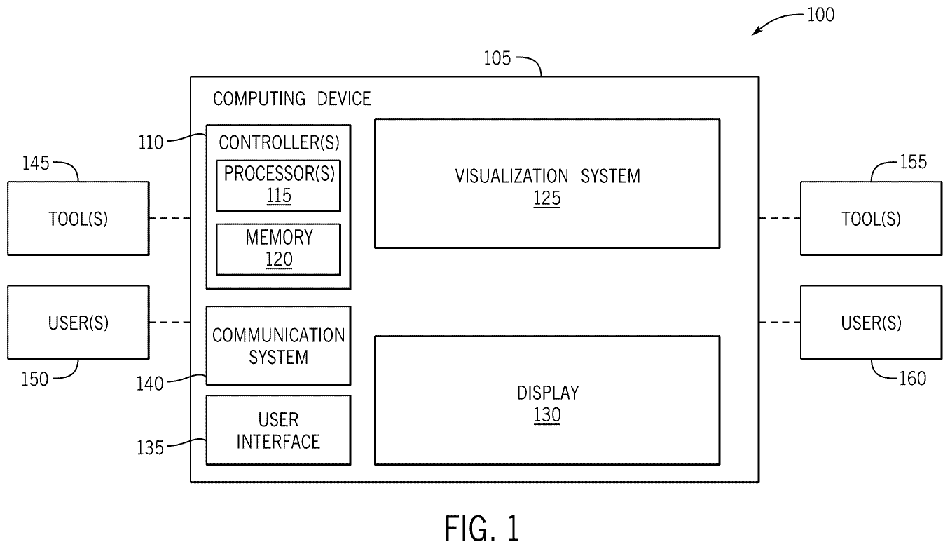

FIG. 1 shows an example of a connected tool system 100. The tool system 100 can include one or more tools (e.g., tools 145, 155, etc.) and a computing device 105. In some examples, the computing device 105 can be implemented as a mobile phone (e.g., a smart phone), a personal digital assistant (“PDA”), a laptop, a notebook, a netbook computer, a tablet computing device, etc. In some examples, the computing device 105 may be configured to communicate directly with the tools 145, 155 via a communication system 140 of the computing device 105. For example, the communication system 140 may permit the computing device 105 to exchange information with the tools 145, 155. In one particular example, the communication system 140 may permit the computing device 105 to receive information from a tool (e.g., tool 145) and output information to another tool (e.g., tool 155). In some examples, the communication system 140 may be a wireless communication system (e.g., a wireless transceiver) or a wired communication system (e.g., via a physical, wired network).

In some examples, the computing device 105 may include one or more controllers 110 each having a processor 115 and a memory 120. The processor 115 can be implemented as a programmable processor, an application specific integrated circuit (ASIC), one or more field programmable gate arrays (FPGAs), a group of processing components, or other suitable electronic processing components. The memory 120 (e.g., memory, memory unit, storage device, etc.) can include one or more devices (e.g., RAM, ROM, Flash memory, hard disk storage, etc.) for storing data or computer code for completing or facilitating the various processes, layers and modules described herein. The memory 120 can be or include volatile memory or non-volatile memory. The memory 120 can include database components, object code components, script components, or any other type of information structure for supporting the various activities and information structures described in the present application.

The computing device 105 may further include a display 130 and a corresponding user interface 135. In some examples, the display 130 and user interface 135 may permit one or more users (e.g., users 150, 160) to interact with the computing device 105. For example, the users 150, 160 may interact with the user interface 135 to input information into the computing device 105. In some examples, the information inputted into the computing device 105 may be depicted on the display 130 for review by the users 150, 160.

In some examples, to facilitate the fabrication of a workpiece (e.g., EMT tubing, conduit, etc.) within a work area, the computing device 105 may include a visualization system 125. The visualization system 125 may be in the form of a mobile application (e.g., computer program) stored within the memory 120 of the computing device 105. The visualization system 125 may permit the users 150, 160 to build and review a three-dimensional (3D) model of a workpiece prior to cutting, bending, or otherwise performing work on the workpiece.

For example, the user may build the 3D model of the workpiece within the visualization system 125 (e.g., using the user interface 135). The user may then input measurements corresponding to one or more segments of the workpiece for analysis by the visualization system. In some examples, the user may take measurements as prompted by the visualization system (e.g., via a tape measure or other tool) and manually input those measurements into the visualization system 125. However, in other examples, the user may utilize one or more connected tools (e.g., tool 145), which may automatically transmit measurements from the tool 145 to the visualization system 125. Based on the inputted measurements, the visualization system 125 may generate instructions that may be followed by the user (e.g., user 160) to cut, bend, or otherwise perform work on the workpiece, without having to perform manual calculations on cut or bend locations for the workpiece. In some examples, more than one connected tool 145 may be connected to the visualization system 125. For examples, different workers may each have a tool (e.g., a tape measure, etc.) that is connected to the visualization system 125.

In some examples, the visualization system 125 may transmit instructions (e.g., via the communication system 140) to one or more connected tools (e.g., tool 155) to perform automated cuts, bends, threading operators, or other operations on the workpiece. Thus, as should be appreciated, the number of manual inputs from the users 150, 160 may be reduced and overall efficiency may be increased.

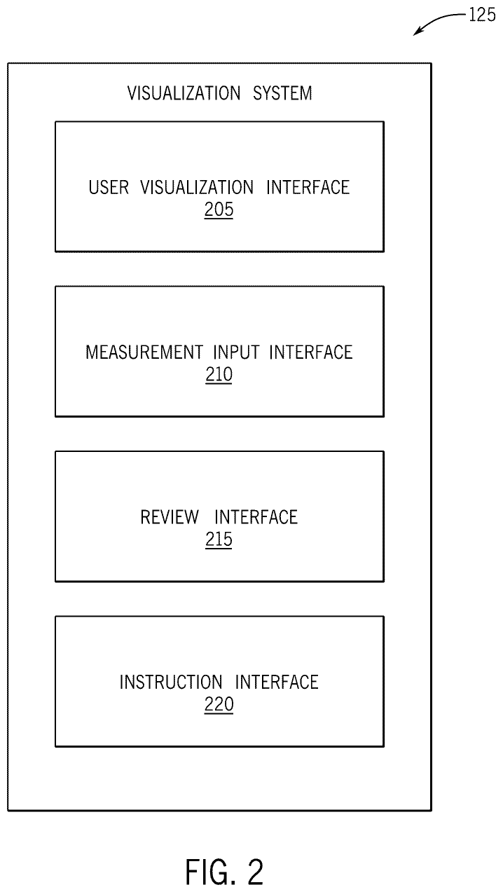

FIG. 2 illustrates one example of components of the visualization system 125. For example, the visualization system 125 may include a user visualization interface 205, a measurement input interface 210, a review interface 215, and an instruction interface 220. In some examples, the user visualization interface 205 may be used to build the 3D model of the workpiece. For example, the user visualization interface 205 may present various workpiece components on the display 130 of the computing device 105. The user may then select from these components via the user interface 135 to build a desired workpiece arrangement (e.g., shape, layout, etc.). In some examples, the user visualization interface 205 may present the user with a real-time visualization of the workpiece.

In some examples, once the user has built the desired 3D model via the user visualization interface, the measurement input interface 210 may prompt the user for measurement information corresponding to predetermined segments of the workpiece. For example, the measurement input interface 210 may prompt the user for measurement information corresponding to various segments of the workpiece as built by the user (e.g., lengths, radii, obstacle locations, etc.). In some examples, the user may take measurements and manually input the measurement information into the measurement input interface. However, in other examples, the user may utilize one or more connected tools (e.g., digital tape measure) wirelessly connected to the computing device 105 (e.g., via the communication system 140) to automatically transmit the measurement information to the measurement input interface.

In some examples, once the user has inputted the requested measurement information, the review interface 215 may permit a user to review the currently designed 3D model. For example, the review interface may permit a user to modify or add one or more cut locations (e.g., cut locations alone the pipe or other workpiece), add one or more parallel runs, or preview the run via an augmented reality (AR) depiction of the designed 3D model, which may be superimposed over a camera-based view of the desired workpiece location. Thus, the user may be able to review the anticipated installation location of the workpiece prior to manufacturing of the workpiece.

In some examples, once the user has reviewed and accepted the desired 3D model, the instruction interface 220 may calculate the bend radii, bend locations, shrinkage, cut locations, etc. needed to form the desired 3D modeled workpiece. The instruction interface 220 may then generate an updated 3D model that includes the bend radii, bend locations, shrinkage, cut locations, lengths, etc. In some examples, the instruction interface 220 may prepare step-by-step instructions for the user to follow to manufacture the workpiece as modeled. In some examples, the instruction interface 220 may prepare and transmit (e.g., via the communication system 140) instructions including the bend radii, bend location, shrinkage, cut locations, etc. to a connected tool (e.g., tool 155). Upon receiving the instructions, the connected tool may automatically manufacture the workpiece as modeled.

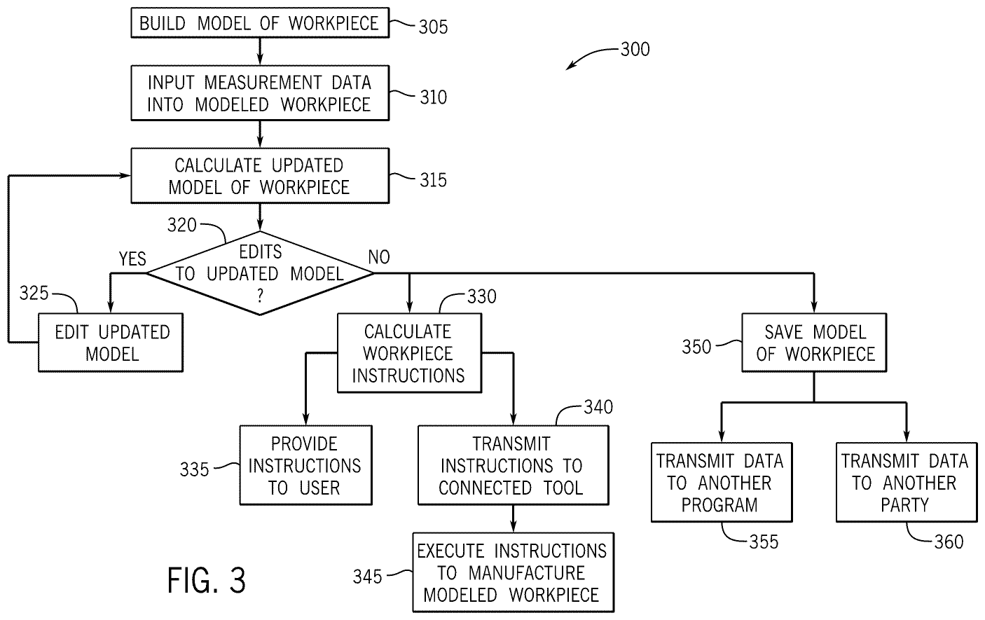

FIG. 3 shows a flowchart 300 of an example use case of the visualization system 125. For example, at stage 305, a user may build a model (e.g., a 3D model) of the desired workpiece using the user visualization interface 205. For example, the user may use the user interface 135 of the computing device to model a desired workpiece extending from a first point to a second point. In some examples, the user may select from modeled workpiece components (e.g., EMT bends, angles, straight components, etc.) to build the model of the desired workpiece. In some examples, the modeled workpiece may be depicted in real-time on the display 130 of the computing device 105.

At stage 310, the user may input measurement data corresponding to predetermined segments (e.g., corresponding to the workpiece components selected at stage 305) of the modeled workpiece into the measurement input interface 210. For example, the measurement input interface 210 may generate prompts requesting measurement information for the predetermined segments of the workpiece. In some examples, the user may measure the distances (e.g., lengths, obstacle locations, bend locations, etc.) as instructed by the prompts and input the measured distances manually into one or more text boxes generated by the measurement input interface 210. In another example, the user may measure the distances (e.g., lengths, obstacle locations, bend locations, etc.) as instructed by the prompts with a connected tool (e.g., a tape measure wirelessly connected to the computing device 105), which may automatically transmit the measured values to the computing device 105 via the communication system 140 and input the measured values into the text boxes generated by the measurement input interface 210.

At stage 315, once the user has inputted the measurement information, the user may instruct to the visualization system 125 to update the workpiece based on the measurement information and enter the review interface 215. For example, the visualization system 125 may calculate the bend angles, bend radii, bend locations, cut lengths, etc. and update the modeled workpiece based on the calculations. At stage 320, the user may review an updated 3D model of the workpiece and determined whether or not further edits to the model are required. If edits to the model are required, at stage 325, the user may edit the model as desired (e.g., adjust lengths, bend radii, cut locations, add parallel rubs, etc.). If edits to the model are not required, at stage 330, the user may move to the instruction interface 220 of the visualization system 125 to calculate instructions for manufacturing of the workpiece.

In some examples, if the user desires, at stage 335, the instruction interface 220 may generate user readable instructions for manufacturing the workpiece, which the user may follow to manually create the workpiece (e.g., using manual pipe benders, saws, etc.). In some examples, the instruction interface 220 may generate step-by-step instructions for manufacturing the workpiece (e.g., including the bend locations, bend radii, cut locations, cut lengths, or other instructions for manufacturing the workpiece). Alternatively or additionally, at stage 340, the instruction interface 220 may generate and transmit instructions for manufacturing the workpiece to a connected tool. In one particular example, the connected tool may be an automated pipe bender configured to automatically bend and shape the workpiece. However, in other examples, other connected tools are envisioned (e.g., pipe threaders, cutters, etc.). At stage 345, once the connected tool has received instructions from the computing device 105 (e.g., via the communication system 140), the connected tool may execute the instructions to manufacture the workpiece.

In some examples, rather than immediately calculating the workpiece instructions at stage 330, the user may instead save the workpiece model for later use at stage 350. For example, the user may save the workpiece model (e.g., 3D model, 2D model, or any combination thereof) within the visualization system 125 for later use. In some examples, the user may access the workpiece model (e.g., through a history tab on the visualization system) in order to perform edits, additions, or further design the workpiece model. In some examples, at stage 355, the user may transmit the workpiece model (e.g., the 3D model, 2D model, or any combination thereof) to another program (e.g., a BIM program, CAD software, another computing device including another visualization system, another connected tool, or other software program) for review, editing, or integration into the other program. Further, in some examples, at stage 360 the user may send (e.g., via email, file upload, etc.) the workpiece model (e.g., the 3D model, 2D model, or any combination thereof) to another party (e.g., user, company, etc.) for review or other documentation purposes.

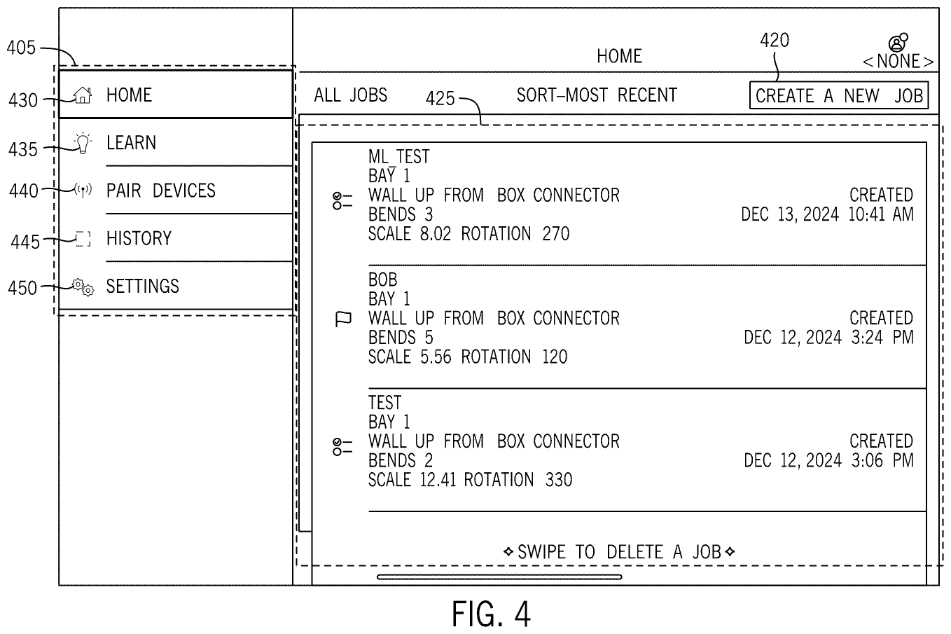

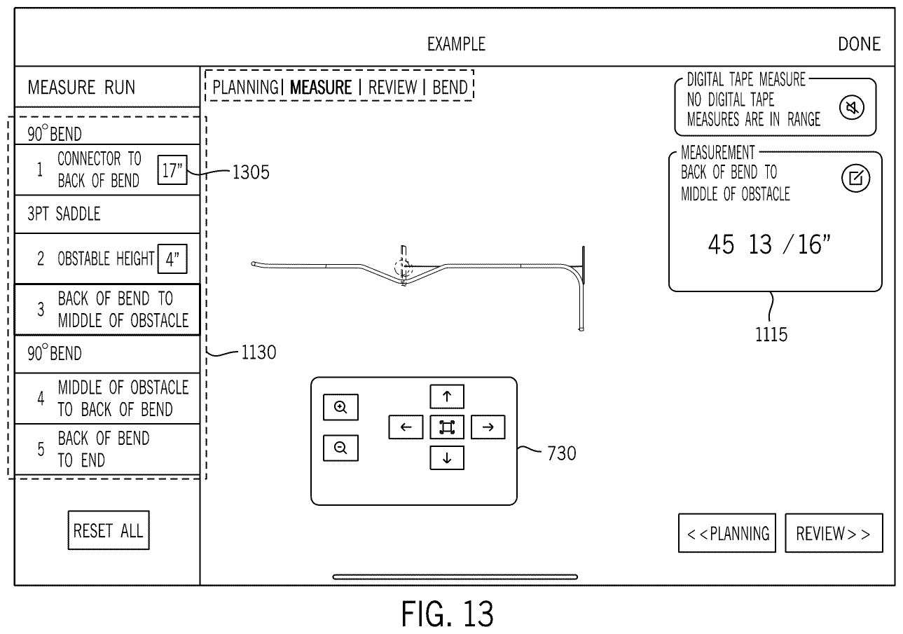

FIGS. 4-20 show an example of the visualization system 125 in use to model and generate manufacturing instructions for a workpiece in the form of electrical metallic tubing (EMT). As should be appreciated, the visualization system 125 may be used to model and generate manufacturing instructions, routing instructions, installation instructions, or other instructions for a variety of other workpieces as desired by a user (e.g., for intermediate metal conduit (IMC), rigid metal conduit (RMC), metal clad (MC) cable, armor clad (AC) cable, copper pipe, carbon steel pipe, polyvinyl chloride (PVC) pipe, or any other known wire, cable, or pipe application). Further, FIGS. 4-20 are discussed in the form of a step-by-step guide for the visualization system 125. However, it is appreciated that the steps discussed with regard to FIGS. 4-20 may be completed in different orders or not completed at all. Further, depending on the use case, there may be additional or alternative steps taken to model and generate manufacturing instructions for a workpiece.

As shown in FIG. 4, upon opening the visualization system 125, a home screen 400 may be presented to a user. The home screen 400 may include a menu 405, which may include one or more buttons (e.g., physical or virtual buttons), which when actuated (e.g., touched, pressed, etc . . . ) may open one or more sub-menus. For example, actuating a home button 430 may return the user to the home screen 400, actuating a learn button 435 may open up a learning sub-menu, actuating a pairing button 440 may open up a pairing sub-menu, actuating a history button 445 may open up a sub-menu depicting historical information (e.g., projects, etc.), and actuating a settings button 450 may open up a setting sub-menu.

In some examples, the learn sub-menu may include training information (e.g., instructions, videos, etc.) to assist a user in learning how to utilize the visualization system 125. The pair devices sub-menu may permit a user to pair one or more devices (e.g., tools) to the visualization system. For example, the user may pair devices to the visualization system wirelessly via Bluetooth, cellular data, Wi-Fi, near field communication (NFC), radio-frequency identification (RFID), or any other known wireless (or wired) communication system.

In some examples, the pair devices sub-menu may further permit a user to connect the visualization system to a building information modeling (BIM) or CAD software (e.g., to permit uploading of a BIM/CAD model to the visualization system). For example, the visualization system can receive data (e.g., pipe size, bend location, distance measurements, orientation, etc.) from a BIM program in order to generate instructions for a bender, user, or other tool to generate the modeled workpiece.

In some examples, a user may utilize the visualization system to build the desired workpiece (e.g., a pipe run) and, after building the workpiece, the user can export the workpiece data to the BIM software. Thus, the user can provide “as build” models to the BIM software to assist in the documentation process. Further, providing the “as built” documentation to the BIM software may permit a user to view a 3D model from the BIM to detect in field overlaps, collisions, or miscommunication with other trades (e.g., during the build process). Further, in some examples, information from the BIM may be usable by the visualization system to generate a bill of materials (e.g., parts list) needed to build the modeled workpiece.

In some examples, the home screen 400 may further include a listing of in-progress or completed jobs, which may be shown in a job list 425. The job list 425 may permit a user to review any in-progress or completed jobs. For example, the user may be able to review information related to the job (e.g., a name of the project, the number of bends, the total amount of rotation, a created date, or other information related to the project), without having to open the project file directly. Thus, if a user wants to edit a project, the user may simply select the project and open the project to make edits or additions.

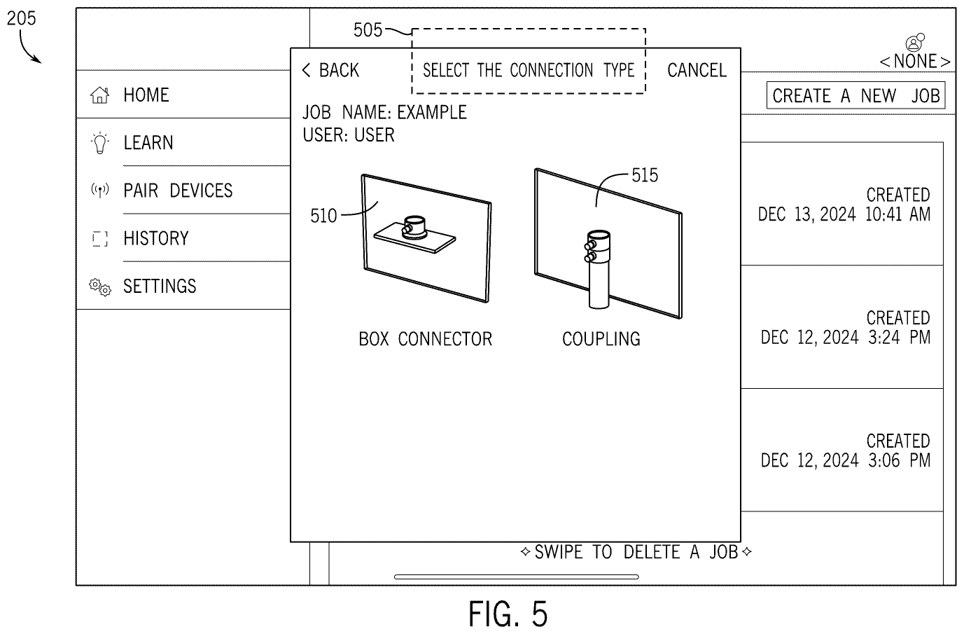

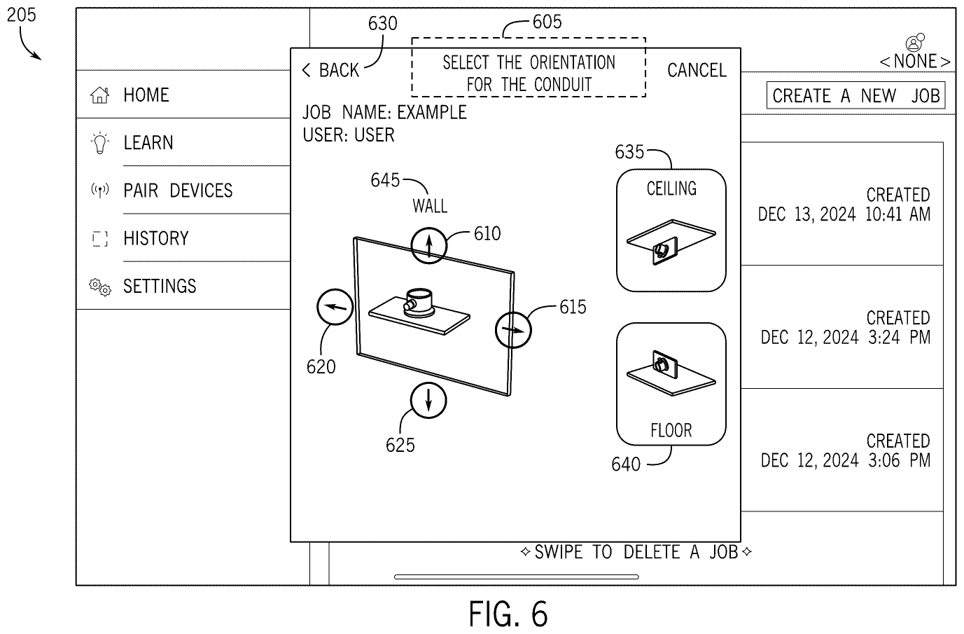

In some examples, looking at FIG. 5, if a user would like to begin a new project (e.g., job), the user may select a new job button 420, which may open up a sub-screen depicting a prompt 505. The prompt 505 may instruct the user to select a connection type for the pipe run (e.g., select one or more different styles of junction boxes 510, couplings 515, or other connectors) to begin the EMT run. In some examples, as shown in FIG. 6, after the selection of the connection type, another prompt 605 may be displayed. The prompt 605 may instruct the user to select a desired orientation for the initial EMT (e.g., conduit) run. For example, the user visualization interface 205 may generate and display a series of arrows indicating EMT run orientations. Thus, the user may select whether the EMT extends in a first direction 610, a second direction 615, a third direction 620, or a fourth direction 625 with respect to the connector (e.g., junction box 510).

In some examples, in addition to selecting a direction for the EMT run, the user may select a location for the connector. For example, the user may select whether the connector is positioned on a wall 645, a ceiling 635, or a floor 640. In some examples, the user visualization interface 205 may include a back button 630 to permit a user to return to a previous stage in the visualization system 125 (e.g., to select different style of connector).

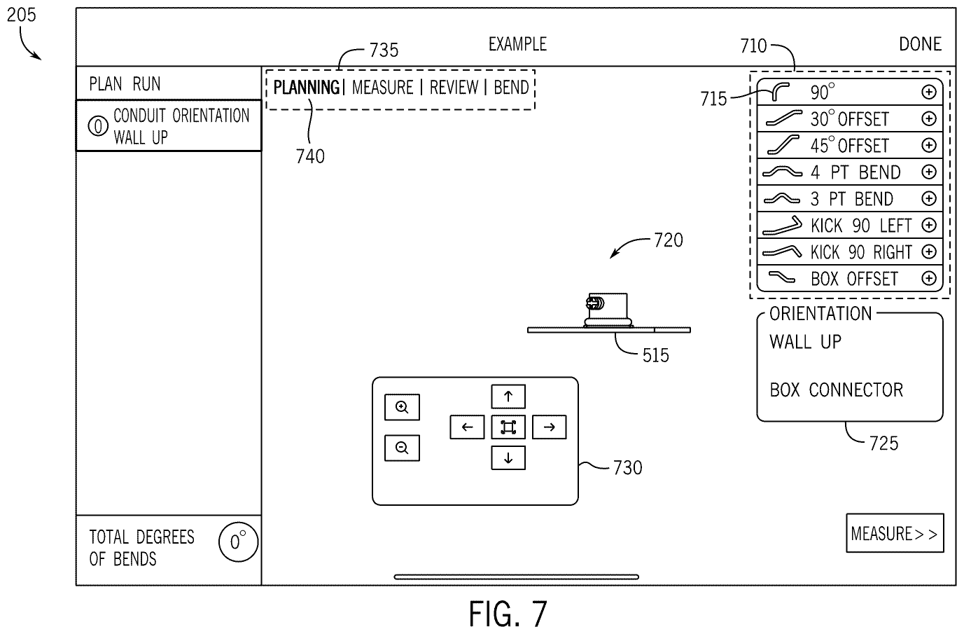

Turning to FIG. 7, once the user has selected the direction for the EMT and the location of the connector, the user visualization interface 205 may generate and depict a real-time 3D model 720 of the workpiece. In some examples, in addition to the 3D model, the user visualization interface 205 may depict a real-time 2D model of the workpiece. Further, the visualization system 125 may include one or more movement controls 730 to permit a user to pan, rotate, zoom, or otherwise adjust a view of the 3D model 720.

In some examples, the visualization system 125 may include an indicator 735 depicting the current stage of the visualization system. For example, as can be seen in FIG. 7, once the user has selected the connector type, the user may enter a planning stage 740. In the planning stage, the user may select a bend (e.g., a first bend) from a menu of bend options 715. For example, the bend options 715 may include a 90-degree bend, an offset bend, a four-point saddle, a three-point saddle, an angle, or any other known bend types. In some examples, the visualization system 125 may further include an orientation indicator 725, which may include information on the selected connector type and connector position that the user selected previously.

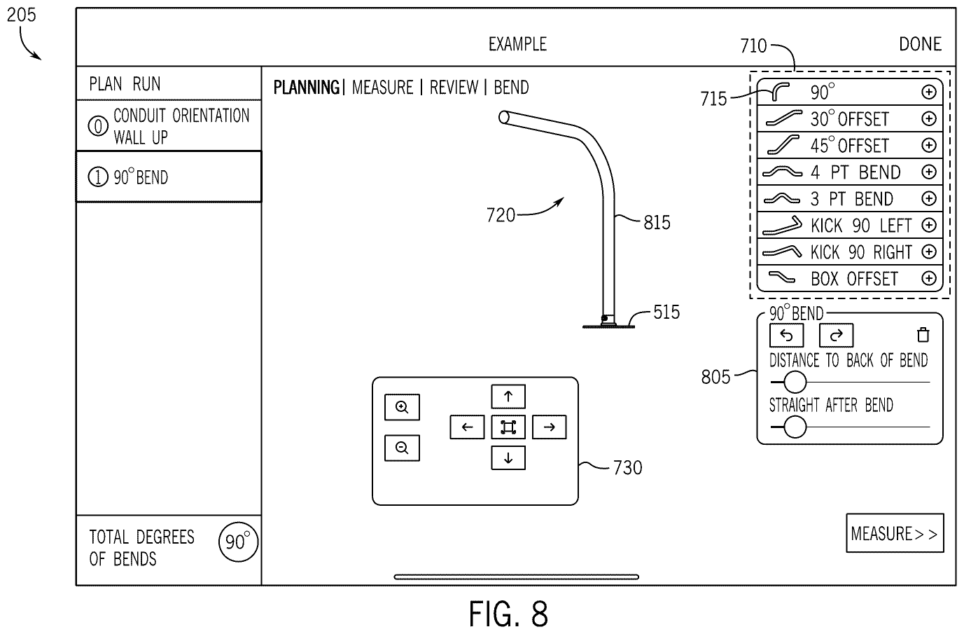

As shown in FIG. 8, upon selection of one of the bend options 715, the 3D model 720 may be updated to include the selected bend 815 at a nominal length and angle. In some examples, the user visualization interface 205 may provide an adjustment interface 805 to permit a user to rotate (e.g., change the orientation) of the bend 815 according to the real-world scenario (e.g., obstacles, etc.), adjust a distance to a back of the bend, and adjust a distance after the bend, or make other adjustments to the model 720. In some cases, when the user selects a bend 715 from the bend menu 710, the user visualization interface 205 may provide the user with options for the bend orientation.

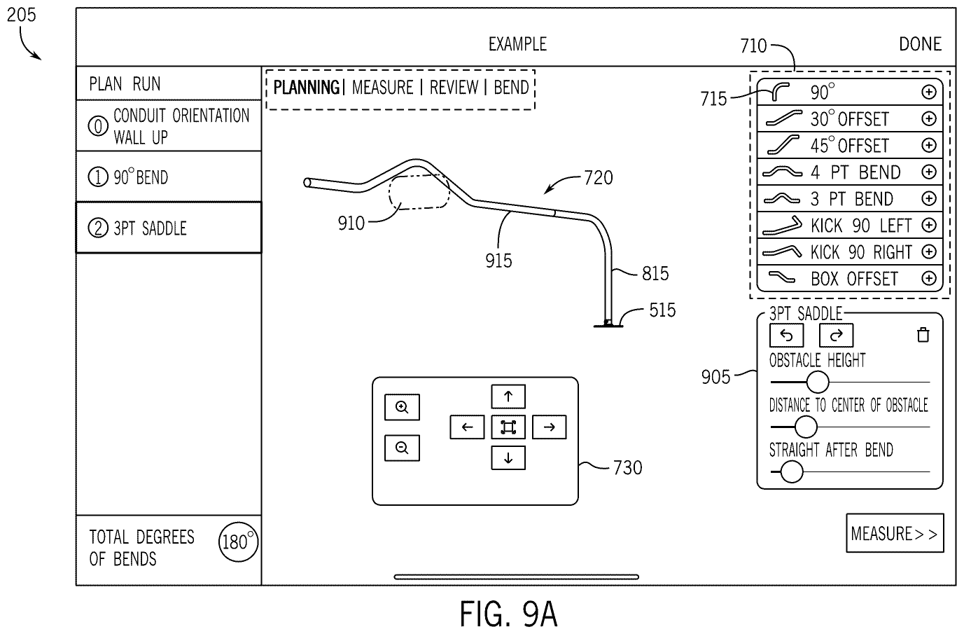

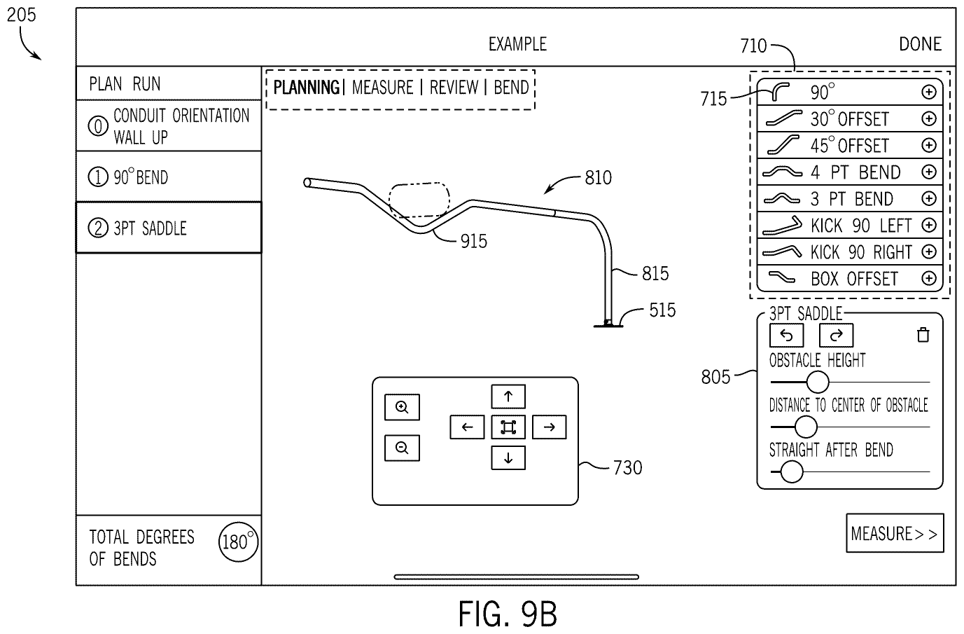

Referring to FIGS. 9A and 9B, the user may continue to select bends 715 from the bend menu 710 as needed to generate the desired 3D model 720. For example, the user may select a bend 915 (e.g., a three-point saddle) to avoid an obstacle 910. Following the selection of the bend 815, the 3D model may be updated to include the selected bend 915 at a nominal length. In some examples, the user visualization interface 205 may provide an adjustment interface 905 to permit a user to rotate (e.g., change the orientation) of the bend 915 according to the real-world scenario (e.g., obstacles, etc.), adjust a distance to a center of the obstacle, and adjust a distance after the bend, adjust a height of the obstacle, or make other adjustments to the model 720. As should be appreciated, in some examples, each of the bends 715 in the bend menu 710 may have a different adjustment interface, which may have different adjustment options depending on the bend type selected.

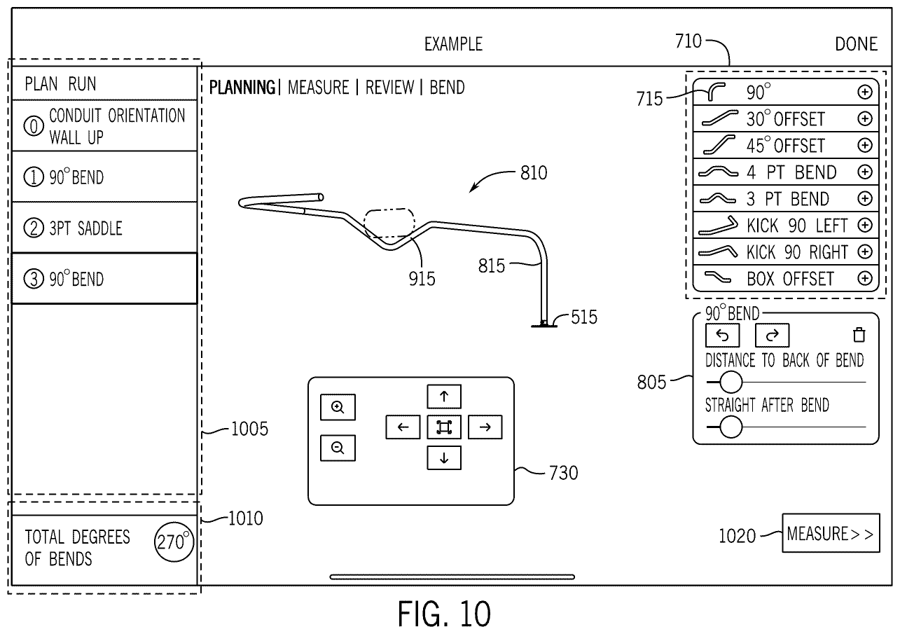

As shown in FIG. 10, as the user continues to build the EMT run, the visualization system may track each of the components of the EMT run in a parts list 1005. The parts list 1005 may depict a number (e.g., sequential number) and name of the components of the EMT run. Further, the visualization system 125 may track the total degrees of bends in the EMT run as shown by indicator 1010. In some examples, the indicator 1010 may track the total degrees of bending and may change color depending on the total degrees of bending. For example, the indicator may be green is the total degrees of bending is below a first threshold value (e.g., 360) degrees, may be yellow if the total degrees of bending is above the first threshold value, but below a second threshold value (e.g., between 270 and 330 degrees), and may be red if the total degrees of bending is above the second threshold value (e.g., 330 degrees). In some examples, the indicator 1010 may be programmed to work with the connected tool, so that if the connected tool has a maximum amount of total bends of 360 degrees, the indicator system will be red if the total degree of bending is over 360 degrees.

In some examples, once the 3D model matches the desired EMT run, the user may move to the next stage in the visualization system 125 (e.g., the measurement stage) by selecting a button 1020 indicating that the EMT run is complete (the user may return and edit the EMT run via button 1125, if desired).

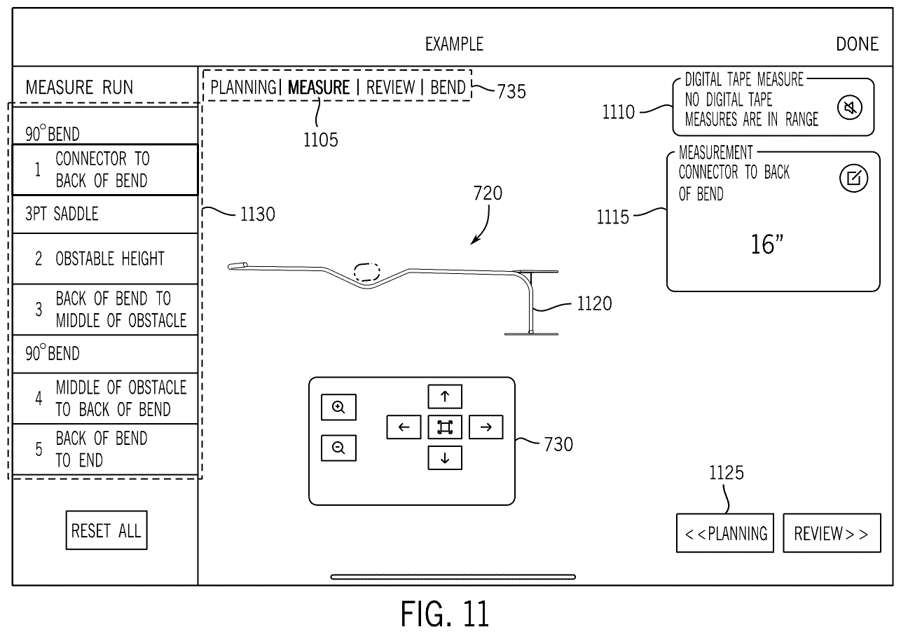

As shown in FIG. 11, the indicator 735 may depict that the visualization system is currently in a measurement stage 1105. In the measurement stage, the measurement input interface 210 may separate the 3D model 720 into one or more segments 1130 corresponding to the previously selected components (e.g., bends, straight segments, etc.) of the model. In some examples, the measurement input interface 210 may convert the 3D model 720 into a live form-fillable document, which may connect to a connected tool (e.g., a connected tape measure). For example, any connected tools may be shown on a display 1110.

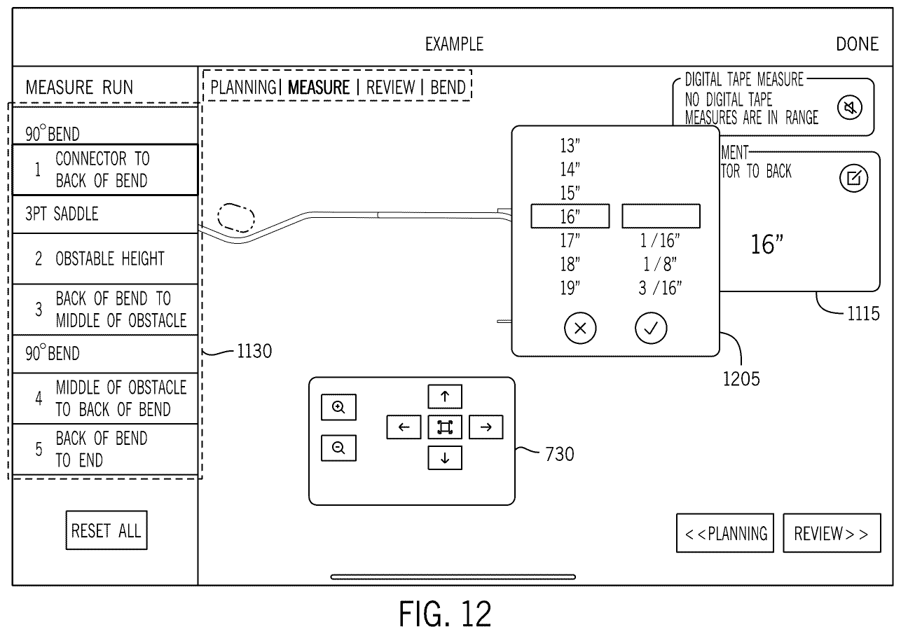

In some examples, the measurement input interface 210 may generate a prompt 1115 to instruct a user to measure each of the generated segments 1130. In some examples, a visual indicator 1120 may additionally provide instructions on where and how to measure the requested dimensions. In some examples, looking to FIG. 12, the measurement input interface 210 may generate one or more text boxes 1205 corresponding to each of the generated segments 1130 of the 3D model. As should be appreciated, the prompts 1115 may instruct the user to take measurements for each of the segments 1130 of the model and input the measurements into the corresponding text box 1205. Further, once the user has taken the measurements as prompted for each of the segments 1130, the measurement may be depicted next to the corresponding segment via a text box 1305. Thus, the user may update the measurements for each segment as desired (e.g., modify the length, etc.) via the selection of the segment (e.g., touching the text box measurement 1305 corresponding to the segment).

In some examples, the user may take the prompted measurements with a measuring tool (e.g., a tape measure) and input the measurements manually into the text boxes 1205. In another example, the user may take the measurements with a connected measuring tool (e.g., a connected tape measure), which may automatically (wirelessly) transmit the measurements to the computing device 105 and input the measurements into the text boxes 1205. In some examples, the user may return and edit the EMT run measurements via button 1410, if desired

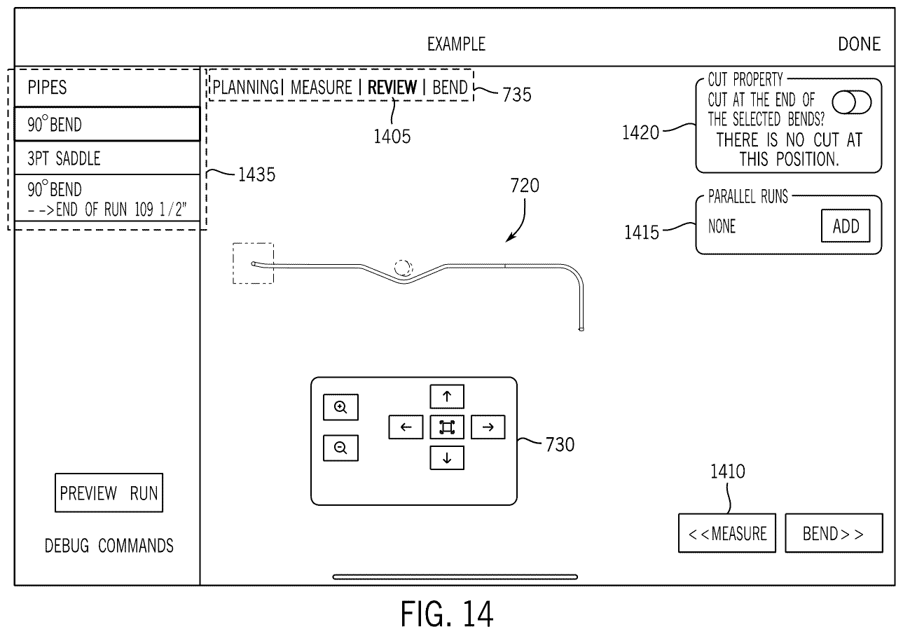

As shown in FIG. 14, the indicator 735 may depict that the visualization system is currently in a review stage 1405. In the review stage, the review interface 215 may provide an overview of the 3D model 720. Further, the review interface 215 may provide a list of selected components in a parts list 1435. In some examples, the parts list 1435 may provide a total length measurement of the EMT run. In some examples, if the total length of the EMT run is above a predetermined value, the EMT run may be split (e.g., separated into separate runs) by the visualization system. For example, if the total length is above 120 inches, the run may be split into two separate runs.

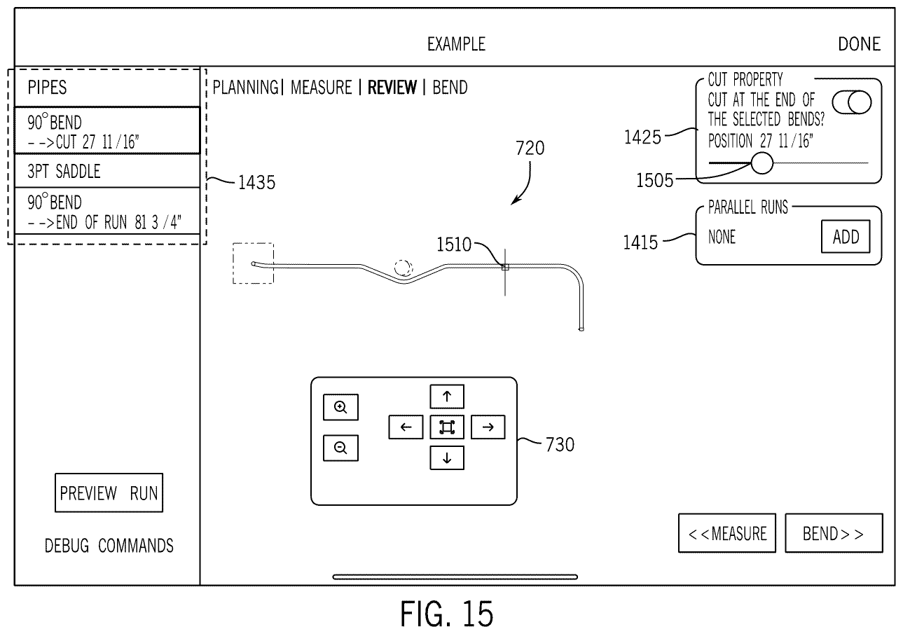

In some examples, the review interface 215 may include a run split toggle switch 1420 (e.g., a virtual switch) to permit the user to select a cut (e.g., split) location along the EMT run. For example, as shown in FIG. 15, if the user toggles the run split toggle switch 1420 into the “on” position, the user may be able to select a cut location along length of the EMT run (e.g., select any location along the length of the EMT run). For example, the user may click and drag on a slider 1505 to select a cut location along the length of the EMT run. In some examples, a run split indicator 1510 may appear on the 3D model to provide a visual indicator of the location of the run split.

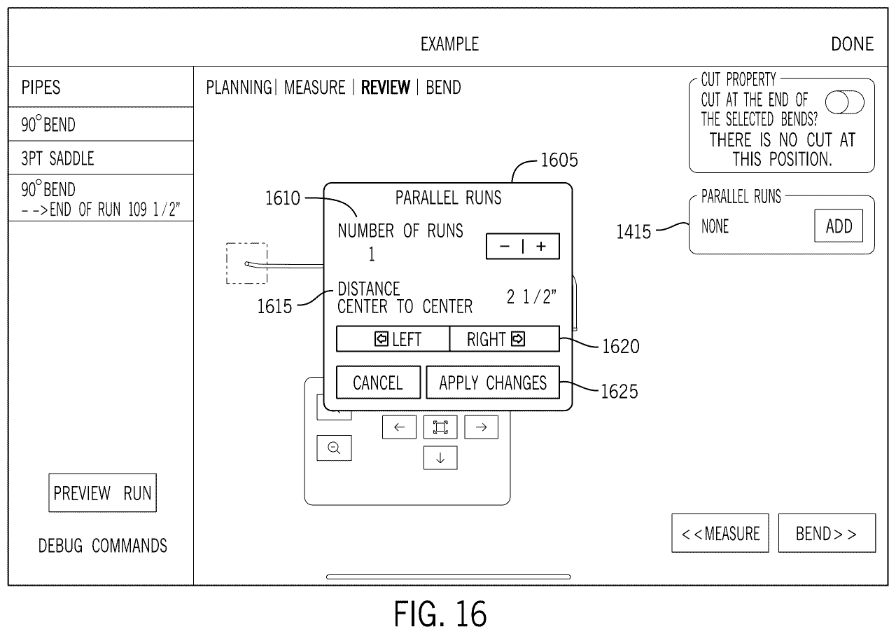

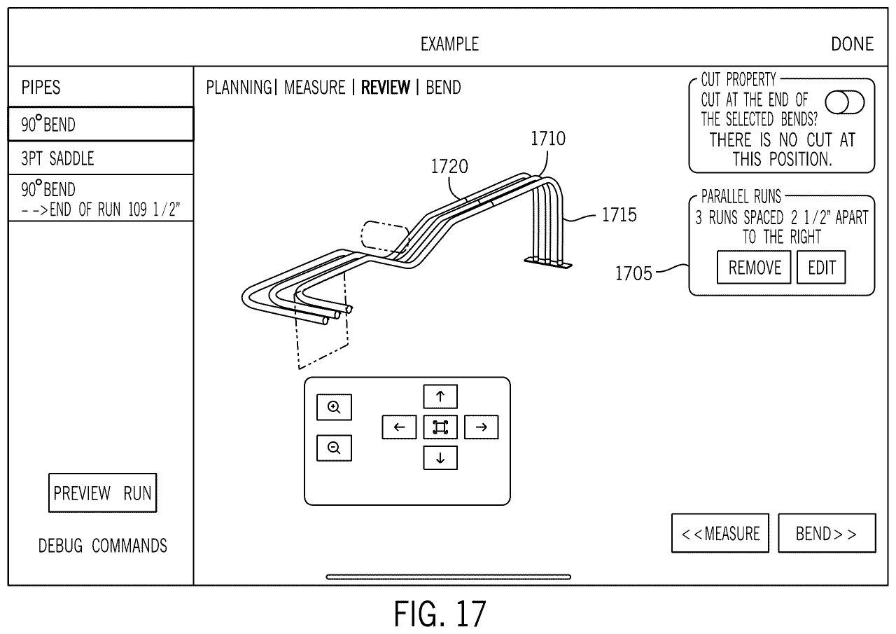

In some examples, the review interface 215 may permit a user to create a parallel EMT run, without taking any further measurements, via the selection of a button 1415. In some examples, as shown in FIGS. 16 and 17, if the user selects to add a parallel EMT run (e.g., parallel runs 1710, 1715) via the button 1415, a pop-up window 1605 may appear in which the user may select the number of parallels desired via button 1610. Further, the user may enter a value into a text box 1615 that corresponds to a spacing (e.g., offset) between the original EMT run 1720 and the parallel EMT runs 1710, 1715. In some examples, the user may further select which direction (e.g., with respect to the original EMT run 1720) to arrange the parallel EMT runs 1710, 1715 (e.g., to the left or right of the original EMT run 1720). Once the user has finalized the 3D model, the user may apply the changes via button 1625, which may generate an updated 3D model (see, e.g., FIG. 17). Further, information related to the parallel runs (e.g., number of total runs, spacing, run direction, etc.) may be depicted via an informational box 1705.

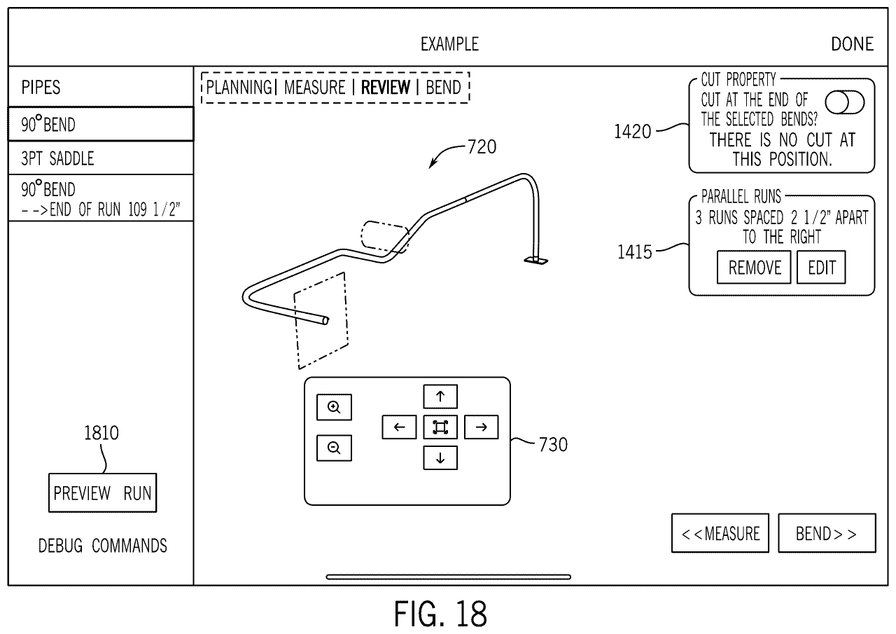

In some examples, as shown in FIG. 18, once a user has finalized the desired EMT run (e.g., as shown by 3D model 720), the user may be able to preview the run in real-time in the workplace. For example, the user may be able to project the 3D modeled run in 3D space via an augmented reality (AR) system. In some examples, in order to permit the use of the AR system, the computing device may have a camera. In other examples, the user may utilize smart glasses with virtual reality (VR) technology preview the run.

In some examples, in order to project the 3D model into the desired location, an anchor point may be required. The anchor point may serve as a known location (e.g., calibration point) for the AR system, so that the system can use the anchor point as a known location to begin the projection of the EMT run. In some examples, the anchor point may be an electrical box, a connector, or a dedicated calibration tool. In some examples, the AR system may permit a user to view the 3D model in the desired location, which may provide an indication of potential contact points, obstacles, or other potential issues prior to manufacturing the EMT run. In some examples, the user may return and edit the EMT run via button 1925, if desired

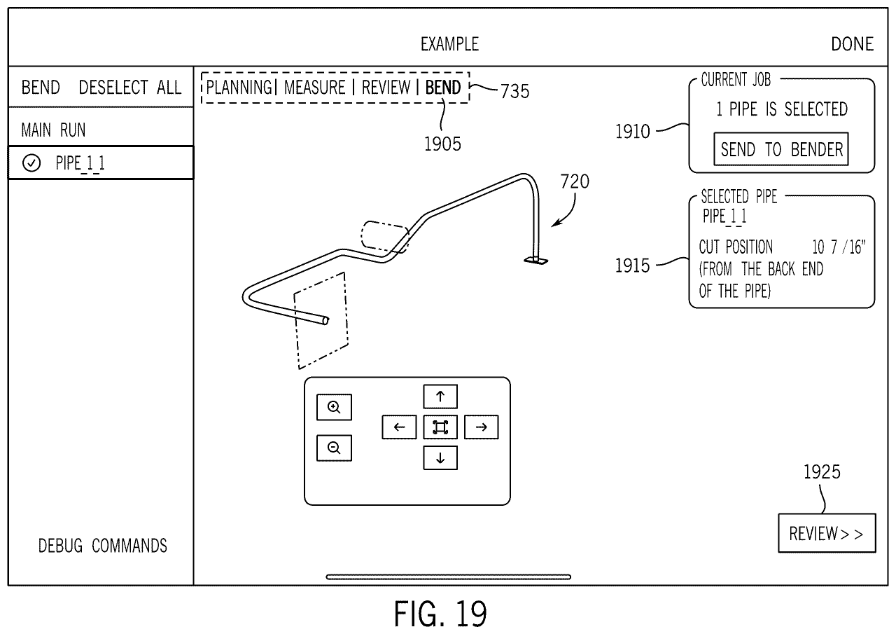

In some examples, as shown in FIG. 19, the indicator 735 may depict that the visualization system is currently in a bend (e.g., manufacturing) stage 1905. In the bend stage, the visualization system 125 may calculate linear lengths, bend angles, bend radii, and other measurements based on the inputted measurement data. Further, the visualization system 125 may right-size (e.g., update) the 3D model 720 based on the measurements and calculations. In some examples, upon transitioning to the instruction interface 220, the user may receive an alert indicating that the overall length of the modeled EMT run 720 is too long and will need to be split into two or more separate EMT runs (see, e.g., previous discussion in FIG. 15). In some examples, a text box 1915 may display the selected EMT run as well as a cut (e.g., split) location along the EMT run.

Once the user is satisfied with the 3D model 720, the user may then select to bend (e.g., manufacture) the EMT run via selection of a button 1910. In some examples, the user may alternatively or additionally select to print (e.g., save, generate step-by-step instructions for, etc.) the EMT run. In some examples, if the user selects to bend the run via the button 1910, the visualization system 125 may generate and send instructions from the computing device 105 to a connected tool (e.g., an automatic bender tool, automatic threading tool, automatic saw, etc.) to instruct the connected tool to manufacture the EMT runs according to the 3D model 720. In another example, if the user selects to print the run, the visualization system 125 may generate step-by-step instructions for the user to follow in order to manufacture the EMT run according to the 3D model 720.

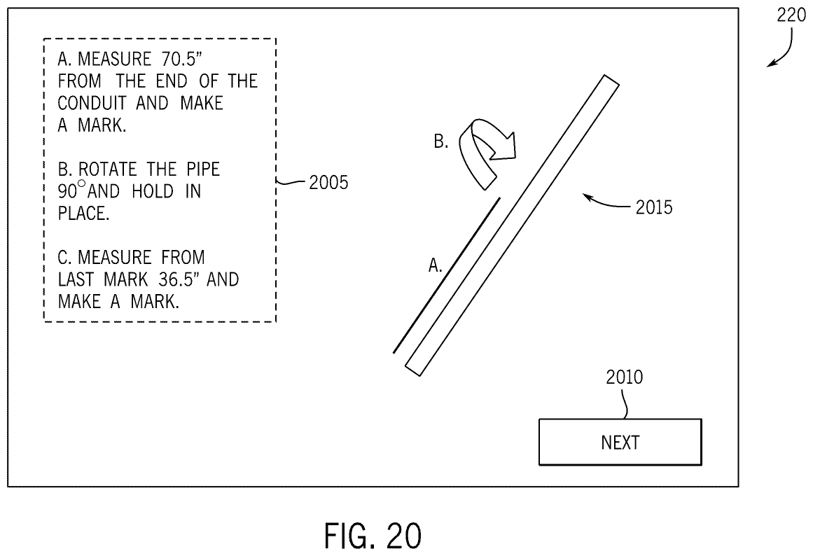

In some examples, as shown in FIG. 20, in addition to step-by-step written instructions 2005, the visualization system 125 may also depict graphic instructions 2015 that correspond to the written instructions 2005. Further, once the user has completed the displayed portion of the instructions, the user may select the button 2010 to advance to further steps in the manufacturing process of the EMT run until completing the manufacture of the 3D modeled EMT run 720. As should be appreciated, utilizing the visualization system 125 permits a user to generate a 3D model of a desired EMT run and identify potential issues with workpiece (e.g., obstructions, etc.) prior to cutting, bending, or otherwise manufacturing the workpiece, which may reduce overall time and material usage.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, aspects of the disclosed technology can be implemented as a set of instructions, tangibly embodied on a non-transitory computer-readable media, such that a processor device can implement the instructions based upon reading the instructions from the computer-readable media. Some examples of the disclosed technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some examples, a control device can include a centralized hub controller that receives, processes and (re) transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosed technology, or of systems executing those methods, may be represented schematically in the figures, or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the disclosed technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A method of manufacturing a workpiece, the method comprising:
building a three-dimensional model of a workpiece within a visualization system stored on computing device;
inputting measurement data into the visualization system, the measurement data corresponding to predetermined segments of the workpiece;
updating the three-dimensional model based on the inputted measurement data to generate an updated three-dimensional model; and
based on the inputted measurement data, manufacturing the workpiece to match the updated three-dimensional model.

2. The method of claim 1, further comprising:
wirelessly transmitting instructions to a tool; and
manufacturing the workpiece, via the tool, to match the updated three-dimensional model in response to the instructions.

3. The method of claim 2, wherein the tool is a pipe bender.

4. The method of claim 1, wherein the measurement data is transmitted to the computing device via a tape measure wirelessly connected to the computing device.

5. The method of claim 1, wherein the measurement data is manually entered into one or more text boxes generated by the visualization system by a user.

6. The method of claim 1, further comprising:
generating a three-dimensional model of a second workpiece parallel to a first workpiece based on the measurement data of the first workpiece; and
manufacturing the second workpiece.

7. The method of claim 1. further comprising:
generating an alert when a total rotational value of the bends in the workpiece is above a threshold value.

8. The method of claim 1, wherein the workpiece is electric metallic tube.

9. A visualization system for manufacturing a workpiece, the visualization system comprising:
a user visualization interface, the user visualization interface to generate a three-dimensional model of a workpiece in response to an input from a user;
a measurement input interface, the measurement input interface to receive measurement data corresponding to predetermined segments of the workpiece; and
an instruction interface, the instruction interface to update the three-dimensional model based on the received measurement data to generate an updated three-dimensional model based on the received measurement data, and the instruction interface to generate instructions for fabrication of the workpiece.

10. The visualization system of claim 9, further comprising:
a tool wirelessly connected to the visualization system.

11. The visualization system of claim 10, wherein the tool receives instructions from the visualization system and manufactures the workpiece to match the updated three-dimensional model.

12. The visualization system of claim 11, wherein the tool is an automatic pipe bender.

13. The visualization system of claim 10, wherein the tool is a digital tape measure.

14. The visualization system of claim 13, wherein the digital tape measure wirelessly transmits the measurement data to the visualization system.

15. The visualization system of claim 9, wherein the workpiece is electric metallic tube.

16. A method of manufacturing a workpiece, the method comprising:
designing a model of a workpiece within a visualization system stored on computing device by:
selecting predetermined segments of the workpiece within the visualization system to build the model of the workpiece, the predetermined segments having a nominal length;
pairing a first connected tool to the visualization system, the first tool wirelessly transmitting measurement data corresponding to the predetermined segments of the workpiece to a measurement input interface of the visualization system;
updating the segments of the model based on the measurement data to generate an updated model with the segments having a length determined by the measurement input interface;
pairing a second connected tool to the visualization system, the second tool wirelessly receiving manufacturing instructions from the visualization system to manufacture the model; and
manufacturing the workpiece via the second connected tool to match the updated model.

17. The method of claim 16, wherein the first tool is a tape measure and the second tool is a pipe bender.

18. The method of claim 16, wherein the model is one of:
a three-dimensional model; or
a two-dimensional model.

19. The method of claim 16, further comprising:
generating a model of a second workpiece parallel to a first workpiece based on the measurement data of the first workpiece; and
manufacturing the second workpiece.

20. The method of claim 16, further comprising:
generating an alert when a total degree of bending in the workpiece is above a threshold value.
